(19) United States
(12) Patent Application Publication
(10) Pub. No.: US 2024/0050208 A1
(43) Pub. Date: Feb. 15, 2024

(54) REUSABLE FLOSSING DEVICE AND METHOD OF USE

(71) Applicant: Mintl LLC, East Hampton, CT (US)

(72) Inventors: Connor BOUTHOT, East Hampton, CT (US); Bartek ZALEWSKI, Newmarket (CA); Asa COUTURE, Aurora (CA)

(73) Assignee: Mintl, LLC, East Hampton, CT (US)

(21) Appl. No.: 18/366,269

(22) Filed: Aug. 7, 2023

Related U.S. Application Data
(60) Provisional application No. 63/397,884, filed on Aug. 14, 2022.

(51) Int. Cl. A61C 15/04

(52) U.S. Cl. CPC A61C 15/046

(57) ABSTRACT

A flossing device and related method of use to aid in holding and tensioning a flossing material during flossing of teeth. The device is closable as a clam shell or may otherwise enclose a portion of flossing material, such as a spool of flossing material. The device includes a tensioning feature to enable a user to adjust exposed flossing material to a desired tension, as well as re-tensioning that material when it becomes slack. The device includes a floss anchor mechanism to aid in retention of flossing material within the device as well as optionally aiding in tensioning of the flossing material. Exposed flossing material is tensioned by means of a slidable mechanism which may be at least partially exposed.

### REFERENCE TO RELATED APPLICATIONS

This application claims the benefit of U.S. Provisional Patent Application Ser. No. 63/397,884, filed Aug. 14, 2022, the entire disclosure of which is incorporated herein by reference.

### TECHNICAL FIELD

The present disclosure relates generally to a device for dispensing rolled material and to a method of use of the device. More particularly, the present disclosure relates to a reusable device which may be used to dispense rolled material, such as dental floss, and to associated methods of use thereof.

### BACKGROUND ART

Flossing is generally considered an essential component of maintaining proper dental health. Plaque and other substances may build up on the surfaces of the teeth and between the teeth. Such build-up may be aesthetically displeasing and may lead to or increase the severity of gum diseases, such as gingivitis, as well as endangering general dental health.

Various means of removing or reducing plaque and other dental buildup have been explored for hundreds of years, from the use of feathers or hair to silken and waxen threads. Individuals, as well as dental professionals, have expressed preferences for different types of floss, with varying strengths, coatings, thicknesses, widths, and other qualities. Though there are water-based dental flossing devices available, commonly known as “water picks”, such means of flossing teeth are generally acknowledged to have a significantly reduced efficacy compared to mechanical flossing, such as through the use of dental floss.

Dental floss is most commonly used wherein an individual cuts a desired length of floss and then wraps the cut length of floss around a finger of each of two hands, placing the floss strand under tension. The floss is then inserted between two teeth and is manipulated to dislodge plaque and food particles from the surfaces of the teeth and from the space defined between two teeth. This methodology, however, requires the person to use both hands to insert the floss into the mouth and to then manipulate the floss. The process can be uncomfortable and inelegant to use.

Disposable dental floss holders are also known in the art. In a disposable dental floss holder, a small implement is provided which is prepackaged with a specified length of floss at a predetermined tension. Typically, known dental floss holders hold the floss in what is known as either an “F-shape” or a “Y-shape”. These known disposable holders tend to limit a consumers' ability to select a preferred type of floss (e.g., waxed or unwaxed), and the devices do not allow customization of the tension of the floss. Such holders are intended to be thrown away after a single use, creating large amounts of plastic waste, which is obviously bad for the environment. Even if a consumer was to desire reusing a disposable flosser, the tension on the dental floss is quickly decreased or lost due to stretching of the exposed length of floss. This reduction in floss tension drastically reduces the effectiveness of the flosser.

A limited number of reusable dental floss holders are available to consumers. Such devices typically generally require a user to manually load and wrap dental floss onto the floss holder. The holders are therefore essentially a reusable version of a disposable flosser. The very limited selection of floss holders which simplify loading or retention of dental floss require custom floss containers, again limiting the selection of floss types for consumers and increasing the cost of the floss itself.

Current flossing devices and methods of use continue to generate significant amounts of waste material through their lack of reusability. Presently known flossing devices also present users with additional difficulties and limitations.

### SUMMARY OF THE INVENTION

The present inventor has recognized that it would be advantageous to provide consumers with a reusable flossing device which enables effective loading and reloading of a preferred type of dental floss and which allows the consumer to customize a degree of tension on the dental floss prior to use. The present inventor further recognized that it would be advantageous to provide a device which enables and re-tensioning of dental floss during or after use should the tension on the floss drop below a desired tension level.

The present disclosure relates generally to a device for holding filament, bands, or strips of material, and related methods of use. More particularly, the present disclosure relates to a reusable device which may be used to dispense rolled material, such as dental floss, and associated methods of use thereof. The reusable dispensing device enables a user to effectively and easily dispense dental floss and to use the dental floss for flossing of an individual's teeth, while maintaining a desired tension of the floss. The dispensing device may further be used to increase or otherwise reset tension of dispensed floss, while maintain the floss in an orientation for use, and further may be reloadable with additional spools or other forms of dental floss for further dispensing. The dispensing device may additionally be configured to enable the use of non-rolled material.

A flossing device which includes multiple components is disclosed. In one embodiment the flossing device includes a first housing section which is configured to receive at least part of a portion of a dental flossing device, such as a spool. This embodiment further incudes a second housing section as well as a tensioning component. The tensioning component may be connected to the first housing section or to the second housing section, or may be at least partially trapped or otherwise partially encased by the first housing section and the second housing section when the flossing device is in a closed configuration. When one of the two housing sections is connected to the tensioning component, the other housing section may optionally be configured to resist motion of the tensioning component, in at least one direction. The tensioning component itself may be configured to resist motion of flossing material, such as by aiding in maintaining tension on dispensed dental floss.

The tensioning component may include one or more floss cleats. One or more of the optional cleats may have smooth or substantially smooth sides, such as where dental floss may be wrapped around the cleat. The one or more optional cleats may include one or more ridges or teeth on a side to aid in retaining wrapped portions of dental floss in a position surrounding or partially surrounding the cleat.

The tensioning component may include one or more ratcheting teeth or other functionally similar features. The ratcheting feature may be used to prevent rotation of a tensioning component or, in one embodiment, undesired sliding of the tensioning component when the tensioning component is slidably connected to at least one other component of the flossing device. Where the tensioning component is connected to one housing of the flossing device or rests against the housing when the flossing device is in an open or partially open configuration, another housing of the flossing device may include a tooth or complementary feature to resist motion of the tensioning component. In some embodiments, when the flossing device is in the closed configuration, the tensioning component may be able to be moved, such as by sliding, particularly in one direction, but movement in the opposite direction may be resisted, such as with a ratchet mechanism.

The tensioning component may be at least partially exposed through one surface or face of the flossing device, such as where a portion of the tensioning component at least partially sticks out of the body of the flossing device, or where a face of the flossing device has an at least partial opening, such as a window, to provide access to the tension component to a user.

The flossing device may include at least one prong from which a length of dental floss may extend or into which a length of dental floss may return, or both. The prong, along with the extended length of dental floss, may define an open volume, such as between the extended dental floss and a face or feature of the flossing device.

One or more of the housings of the flossing device may include subcomponents, such as where one housing is itself made up of an external housing component and an internal chassis component. The external housing component or internal chassis component may seat against or at least partially within the housing component. In such a way, molding, machining, time, and other factors in manufacturing complexity and costs may be reduced. The flossing device may further include at least one guide feature to aid in directing or retaining a length of floss relative to where the floss exits or enters the flossing device. In particular, the at least one guide feature is configured to direct a length of flossing material out of the flossing device or into the flossing device. Such a guide feature, or a plurality of guide features, may be located on or at least partially within a housing, a chassis component, or a housing component of the flossing device

Where multiple housings are present, one or more housings may be connected by means of a hinge. The hinge may be a mechanical hinge or a living hinge. Other means of connection, whether rotatable connection, slidable connection, press fits, snap fits, fasteners, or other means known in the art, may also or alternatively be used.

To aid in retention of one or more housings when in the closed configuration, the flossing device may include one or more locking features. In one embodiment, the flossing device includes two locking features with one being located on the front of the flossing device and the other being located on the back of the locking device, and both being relatively distal to the hinge, when present. The locking mechanisms may be slide locks, though other means of locking may also be used. Furthermore, a greater or lesser number of locking mechanisms may be used.

The flossing device may be configured to receive and optionally retain a spool or other unit of dental floss therein. In one embodiment, a spool of dental floss may be inserted into the flossing device when the device is in an at least partially open configuration. When the flossing device is moved to a closed configuration, the spool of dental floss is fully enclosed in the flossing device.

The flossing device may further include an optional floss cutter or cutting blade. The blade may be external to the flossing device or may be at least partially internal to the flossing device. In one embodiment, the floss cutter is connected to one of the housings of the flossing device and is accessible when the flossing device is in the open configuration. The floss cutter or cutting blade, however, is fully enclosed by the flossing device when the flossing device is in a closed configuration.

In some embodiments, the flossing device or one or more subcomponents of the flossing device, may be made of recyclable materials or generally eco-friendly materials, such as plastics with a high recyclability rating or biodegradable or controlled-degradability materials. In a preferred embodiment, as many of the components of the flossing device are made of recyclable materials as is functionally feasible and as is cost effective and reasonable for manufacturability.

The disclosure relates to a flossing device and method of use such as through the use of the described invention. The method may include the use of a flossing device which may include one or more of the features or components described herein. Any number of components or features may be used in conjunction with and be incorporated into the flossing device described. Various materials, including metals, plastics, and composites, may be used for the described components and features.

It is to be understood that the above-mentioned features and the features yet to be explained hereinafter can be used not only in the respectively mentioned combinations but also in other combinations, or alone without departing from the context of the present invention.

In one aspect, an exemplary embodiment of the present disclosure may provide a flossing device comprising a first housing section configured to at least partially receive a unit of flossing material therein; and a second housing section; wherein at least one of the first housing section and the second housing section is further configured to at least partially receive a tensioning component, the other of the first housing section or the second housing section being configured to aid in retention of the tensioning component when the flossing device is in a closed configuration, and the tensioning component is configured to resist motion of a portion of flossing material of the unit of flossing material when the flossing device is in the closed configuration.

In another aspect, an exemplary embodiment of the present disclosure may provide a flossing device comprising a first housing section; a second housing section; a tensioning component; a mechanical hinge connecting the first housing section and second housing section to one another, wherein the first housing section and second housing section are movable relative to one another between a closed configuration and an open configuration; at least one locking mechanism configured to aid in retention of the flossing device in the closed configuration; wherein the tensioning component is slidably connected to the first housing section and the tensioning component comprises two floss retention cleats, wherein the two floss retention cleats are configured to resist motion of a length of dental floss when the length of dental floss is wrapped at least partially around and between the two floss retention cleats; wherein the tensioning component further comprises at least one tensioning tooth; and at least one motion-resistance tooth provided on one of the first housing section and the second housing section, wherein the at least one motion-resistance tooth is configured to resist motion of the tensioning component when the flossing device is in the closed configuration.

In another aspect, an exemplary embodiment of the present disclosure may provide a method of using a flossing device comprising inserting a spool of flossing material into a first housing section of a flossing device; extending a length of dental floss from the spool of flossing material; at least partially wrapping at least a first portion of the length of dental floss around a first cleat of the flossing device; extending at least a second portion of the length of dental floss out of the flossing device through a first prong of the flossing device; returning at least a third portion of the length of dental floss into the flossing device through a second prong; and at least partially wrapping a fourth portion of the length of dental floss around a second cleat of a tensioning component; wherein the flossing device comprises a second housing section configured to resist motion of the tensioning component in at least one direction when the flossing device is in a closed configuration. The method may further comprise cutting a fifth portion of the length of dental floss off from the fourth portion of the length of dental floss using a floss cutter which is connected to the flossing device and is fully enclosed by the first housing section and the second housing section when the flossing device is in the closed configuration.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a front, top, left side, isometric perspective view of an embodiment of a reusable flossing device of the present disclosure, shown in a closed configuration;

FIG. 1A is an exploded perspective view of the embodiment of the reusable flossing device of FIG. 1;

FIG. 2 shows a rear, top, left side isometric perspective view of the embodiment of the reusable flossing device of FIG. 1;

FIG. 3 shows a left side elevation view of the embodiment of the reusable flossing device of FIG. 1;

FIG. 4 shows a right side elevation view of the embodiment of the reusable flossing device of FIG. 1;

FIG. 5 shows a front elevation view of the embodiment of the reusable flossing device of FIG. 1;

FIG. 6 shows a rear elevation view of the embodiment of the reusable flossing device of FIG. 1;

FIG. 7 shows a top plan view of the embodiment of the reusable flossing device of FIG. 1, shown in an open configuration;

FIG. 8 shows a rear elevation view of the embodiment of the reusable flossing device of FIG. 7;

FIG. 9 shows a cross-sectional view of the embodiment of the reusable flossing device taken along line 9-9 of FIG. 7;

FIG. 10 shows a first isometric perspective view of the embodiment of the reusable flossing device of FIG. 7;

FIG. 11 shows a second isometric perspective view of the embodiment of the reusable flossing device of FIG. 7;

FIG. 12 shows a first fragmentary isometric perspective view of the embodiment of the reusable flossing device shown in FIG. 11;

FIG. 13 shows a second fragmentary isometric perspective view of the embodiment of the reusable flossing device shown in FIG. 11;

FIG. 14 shows an isometric perspective view of an embodiment of a second chassis component of the embodiment of a reusable flossing device of the present disclosure shown in FIG. 7;

FIG. 15 shows a fragmentary isometric perspective view of the embodiment of the second chassis component of FIG. 14;

FIG. 16 shows an isometric perspective view of an embodiment of a housing component of the second housing section of the embodiment of a reusable flossing device of the present disclosure shown in FIG. 7;

FIG. 17 shows a fragmentary isometric perspective view of the embodiment of the housing component of FIG. 16;

FIG. 18 shows a first isometric perspective view of an embodiment of a floss anchor subassembly of the embodiment of a reusable flossing device of the present disclosure shown in FIG. 7;

FIG. 19 shows a second isometric perspective view of the embodiment of the floss anchor subassembly of FIG. 18;

FIG. 20 shows a third isometric perspective view of the embodiment of the floss anchor subassembly of FIG. 18;

FIG. 21 shows a fourth isometric perspective view of the embodiment of the floss anchor subassembly of FIG. 18 shown in an exploded configuration;

FIG. 22 shows a side elevation view of the embodiment of the floss anchor subassembly of FIG. 18;

FIG. 23 shows a longitudinal-sectional view of the embodiment of the floss anchor subassembly taken along line 23-23 of FIG. 20;

FIG. 24 shows a cross-sectional view of the embodiment of the floss anchor subassembly taken along line 24-24 of FIG. 22;

FIG. 25 shows a first isometric perspective view of an embodiment of a slider component of the embodiment of the floss anchor subassembly of FIG. 18;

FIG. 26 shows a second isometric perspective view of the embodiment of the slider component of FIG. 25;

FIG. 27 shows a side elevation view of the embodiment of the slider component of FIG. 25;

FIG. 28 shows a longitudinal-sectional view of the embodiment of the slider component taken along line 28-28 of FIG. 25;

FIG. 29 shows a cross-sectional view of the embodiment of the slider component taken along line 29-29 of FIG. 27;

FIG. 30 shows a first isometric perspective view of an embodiment of a cleat fixture of the embodiment of the floss anchor subassembly of FIG. 18;

FIG. 31 shows a second isometric perspective view of the embodiment of the cleat fixture of FIG. 30;

FIG. 32 shows a side elevation view of the embodiment of the cleat fixture of FIG. 30;

FIG. 33 shows a longitudinal-sectional view of the embodiment of the cleat fixture taken along line 33-33 of FIG. 30;

FIG. 34 shows a cross-sectional view of the embodiment of the cleat fixture of FIG. 30 taken along line 34-34 of FIG. 32;

FIG. 35 shows a first isometric perspective view of an embodiment of a monolithic floss anchor of the embodiment of a reusable flossing device of the present disclosure shown in FIG. 7;

FIG. 36 shows a second isometric perspective view of the embodiment of the monolithic floss anchor of FIG. 35;

FIG. 37 shows a first isometric perspective view of an alternate embodiment of the monolithic floss anchor of the reusable flossing device of the present disclosure;

FIG. 38 shows a second isometric perspective view of the embodiment of the monolithic floss anchor of FIG. 37;

FIG. 39 shows a third isometric perspective view of the embodiment of the monolithic floss anchor of FIG. 37;

FIG. 40 shows a plan view of the embodiment of the monolithic floss anchor of FIG. 37; and

FIG. 41 shows a side elevation view of the embodiment of the monolithic floss anchor of FIG. 37.

### DETAILED DESCRIPTION

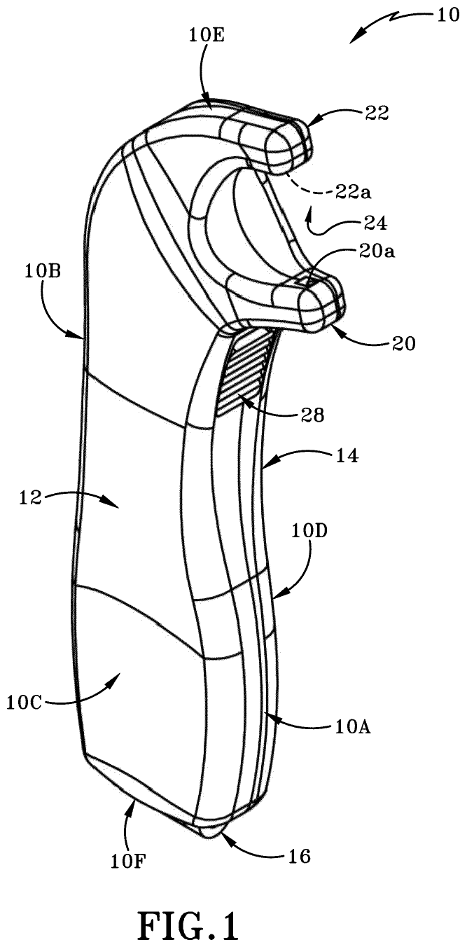

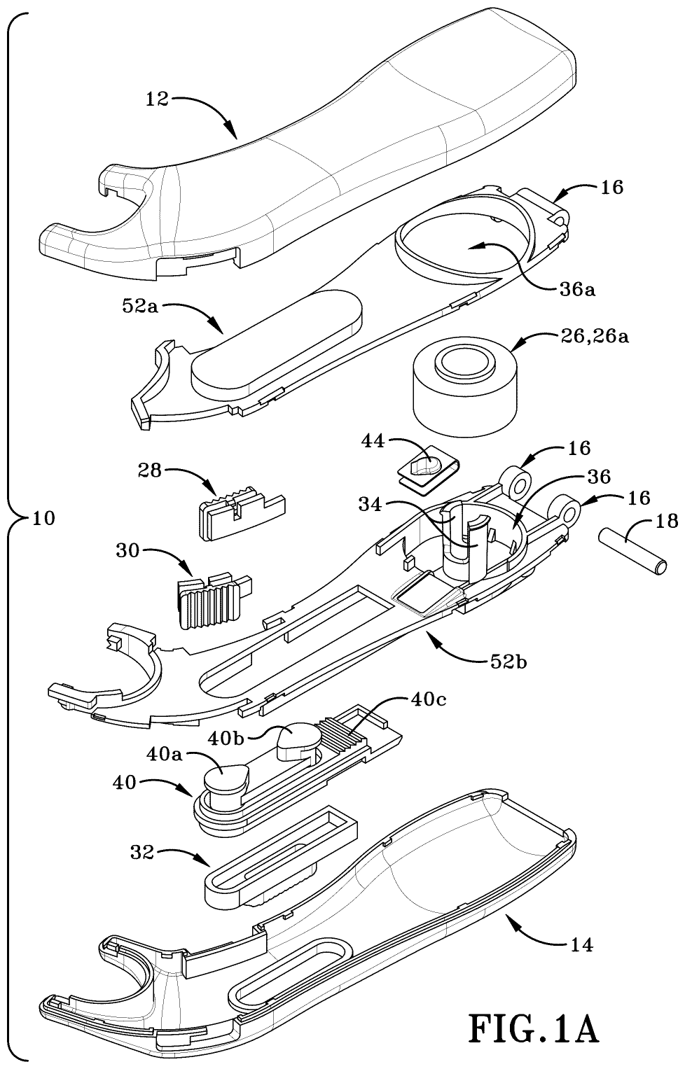

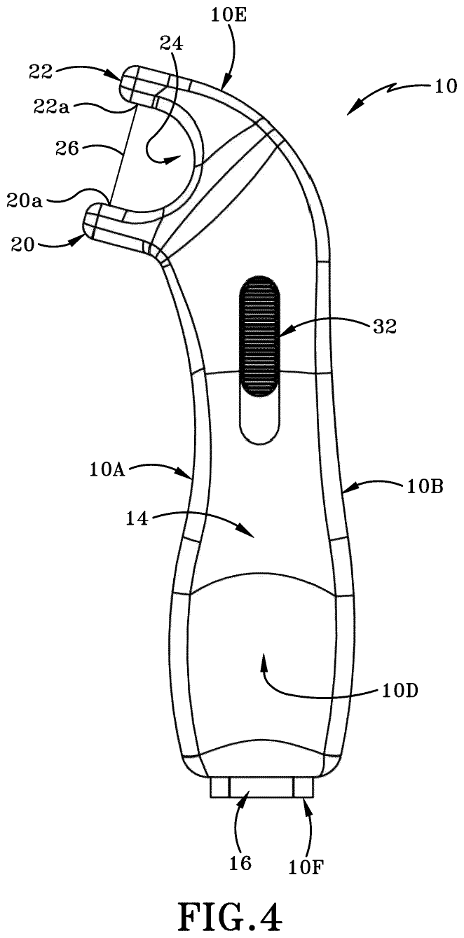

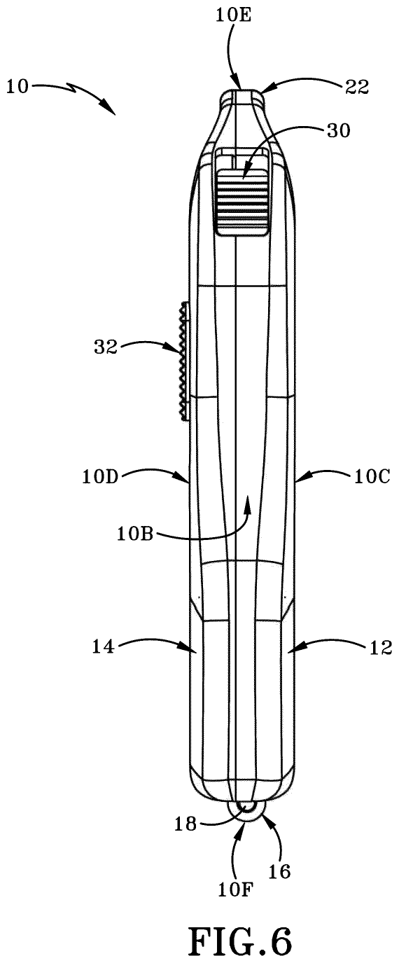

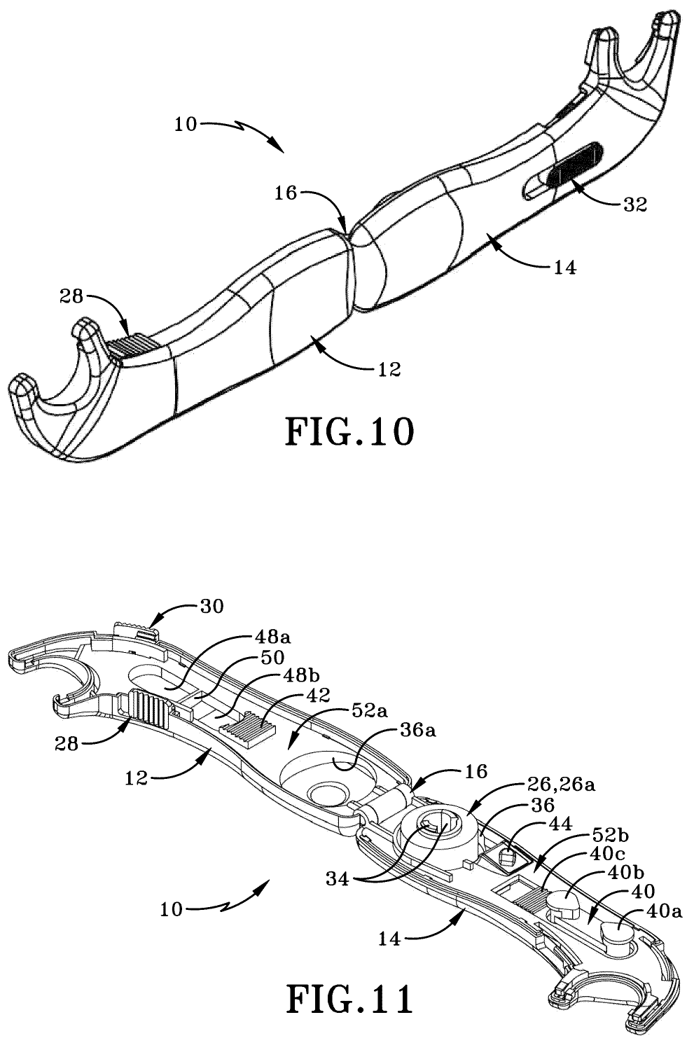

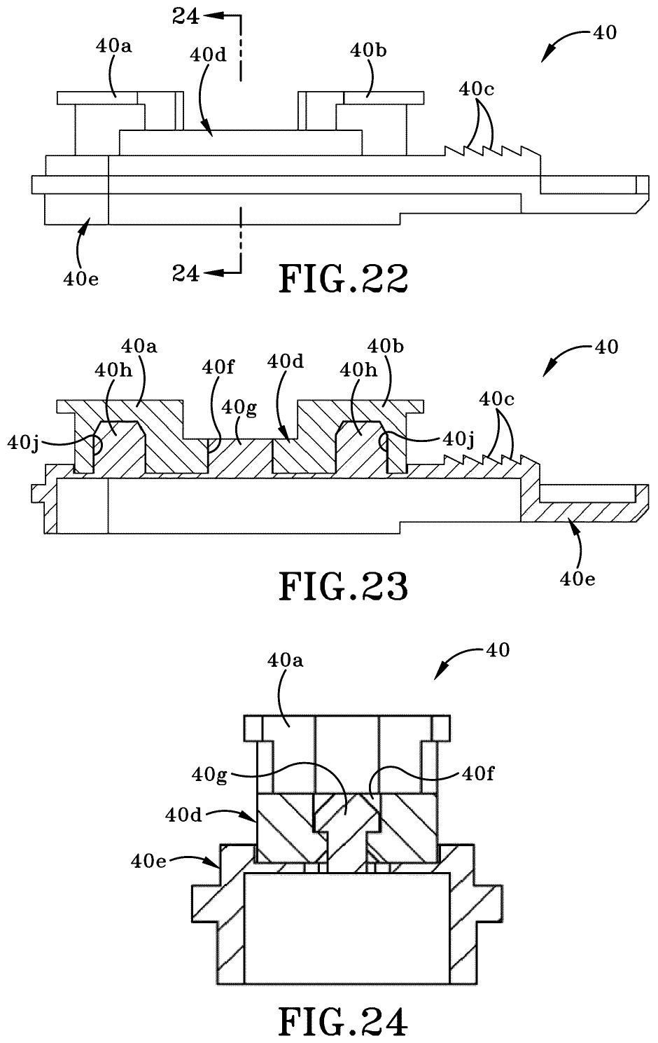

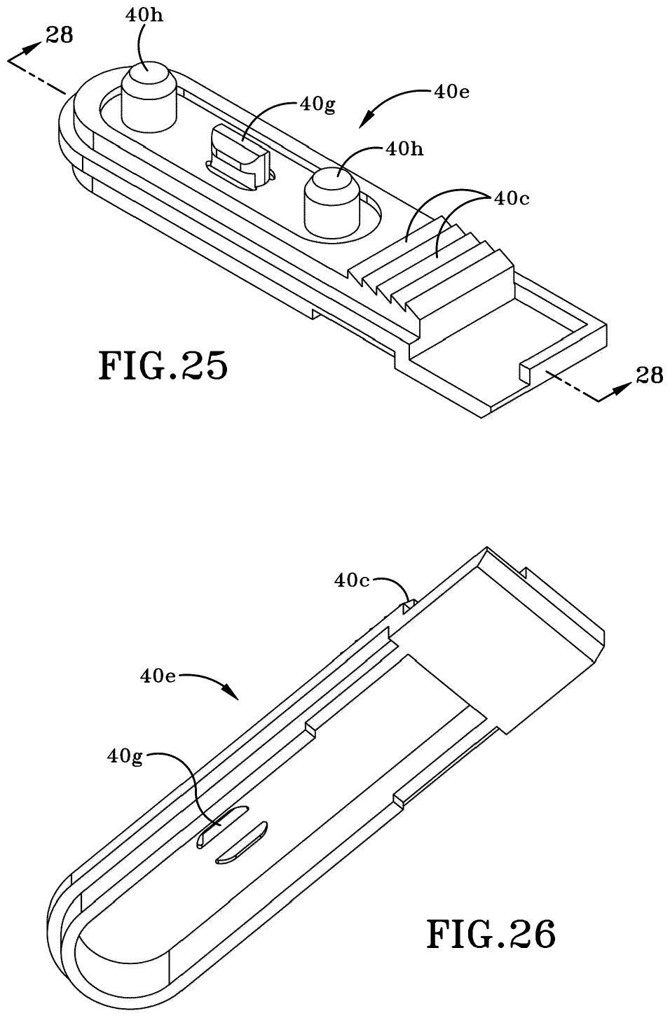

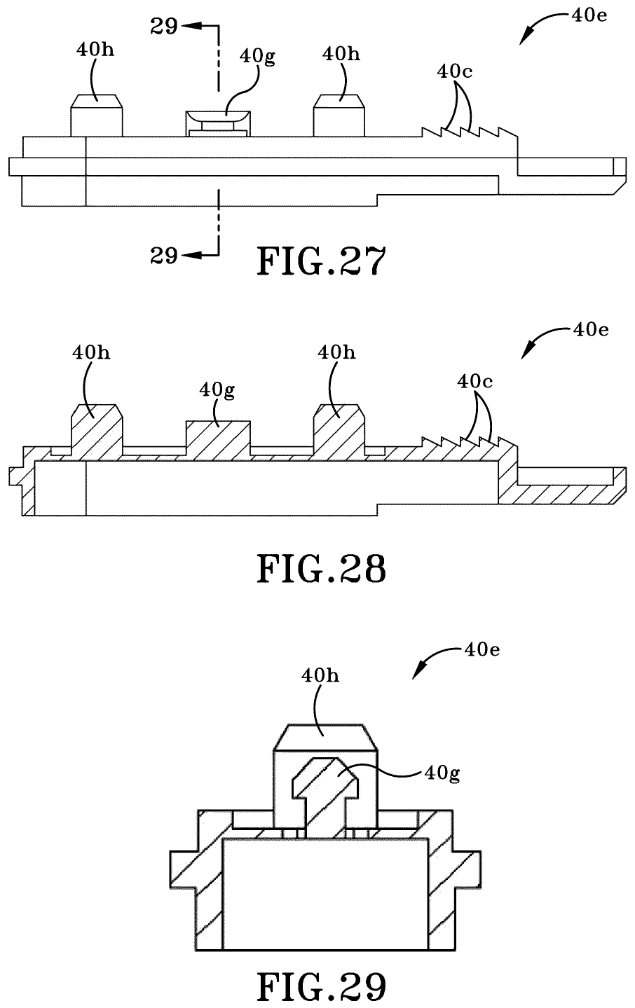

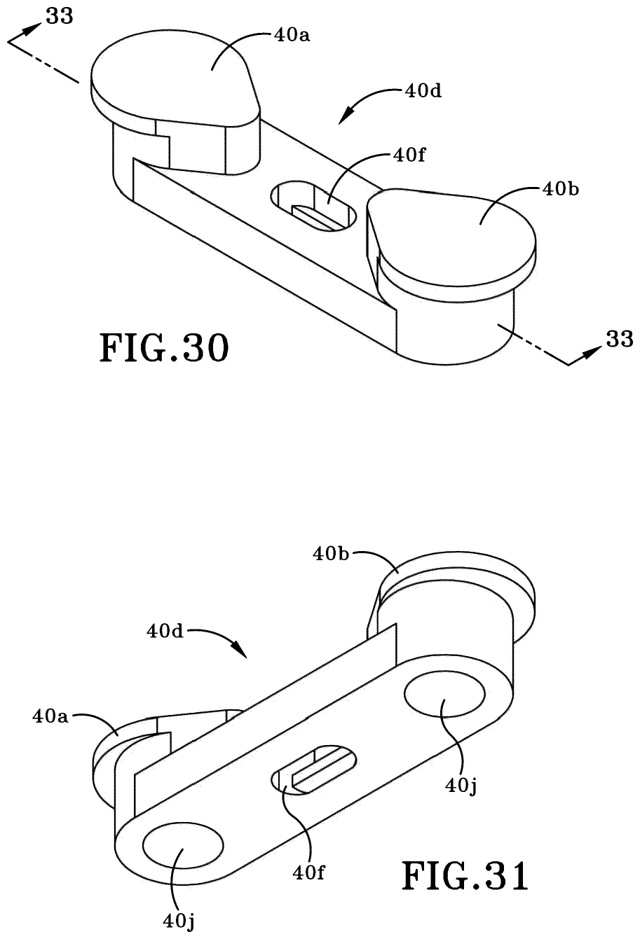

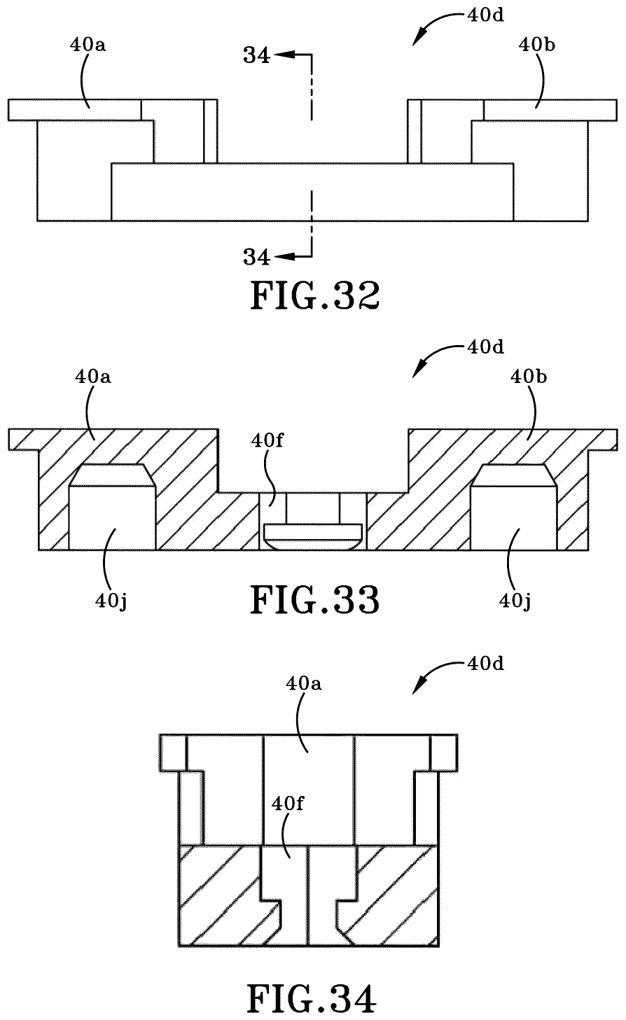

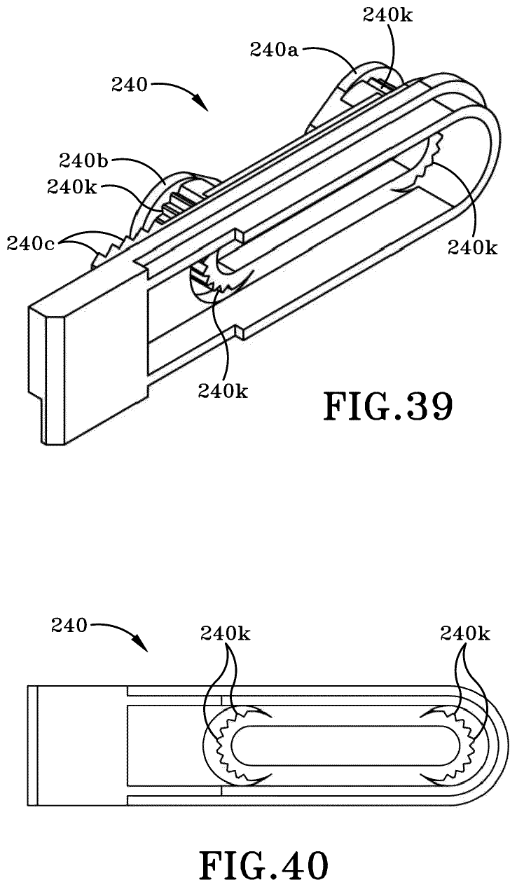

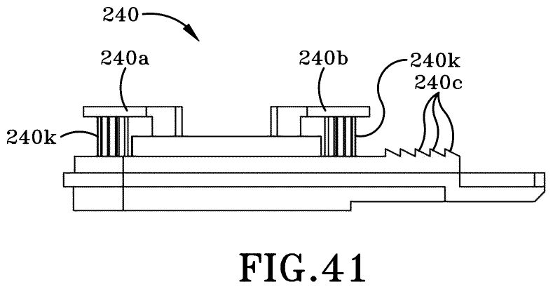

Exemplary embodiments of the disclosure are illustrated in FIGS. 1 to 41 and are explained in the following description in more detail, wherein identical, or similar, reference numbers refer to identical, or similar, or functionally identical or similar components.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features or those previously described are omitted or simplified in order not to obscure the illustrative embodiments.

Various operations may be described as multiple discrete operations, in turn, in a manner that is most helpful in understanding the present invention, however the order of description should not be construed as to imply that these operations are necessarily order dependent. In particular, these operations need not be performed in the order of presentation. In some instances, structures and devices may be shown in block diagram or flow chart form in order to facilitate describing the disclosed subject matter.

An embodiment of a reusable flossing device is shown in FIGS. 1-6, generally indicated at 10. Flossing device 10 is shown in FIGS. 1-6 in a closed configuration, such as for storage or such as when dental floss has been loaded and the device is prepared for use. In the embodiment shown, flossing device 10 includes a housing which may be comprised of a first housing section 12 and a second housing section 14 within which a plurality of components is received. First housing section 12 and second housing component 14 together form a contoured gripping portion which may be grasped in a left hand or right hand of a user. The gripping portion may be sized and contoured so as to ergonomically enable the user to more comfortably hold flossing device 10 during flossing of the user's teeth.

Flossing device 10 may include one or more contoured surfaces, such as those featuring prominences, recesses, or a combination of both. Flossing device 10 may also optionally include one or more substantially straight, linear, or planar surfaces. In the embodiment shown, flossing device 10 is shaped, when viewed from the side, in a fashion to both be complementary to the internal contours of a user's hand as well as to at least partially mimic a form factor that the user may be accustomed to from the use of disposable floss holders. It should, however, be understood that flossing device 10 may have other shapes without deviating from the scope or intent of this disclosure, including, but not limited to, substantially rectangular shapes, substantially triangular shapes, other polygonal shapes, elliptical shapes, hybrid shapes, and others.

First housing section 12 and second housing section 14 of flossing device 10 are further configured to form a prong region which extends outwardly from one end of the contoured gripping portion. As will be later described herein, the prong region retains a length of dental floss therein for use in flossing the user's teeth.

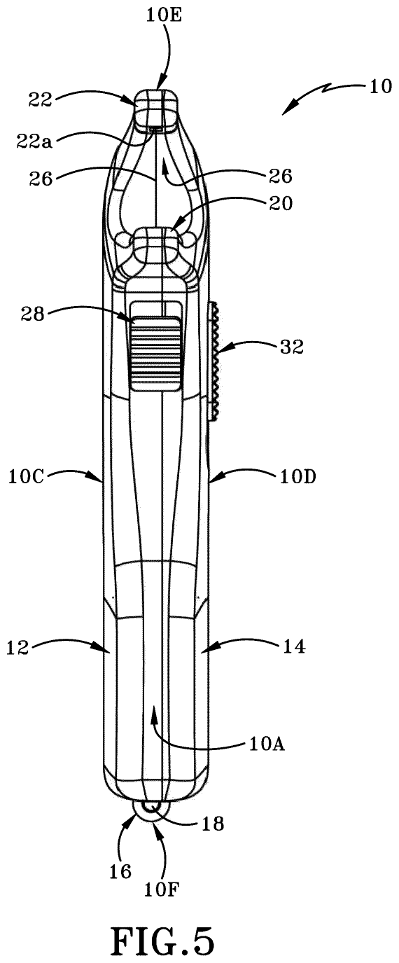

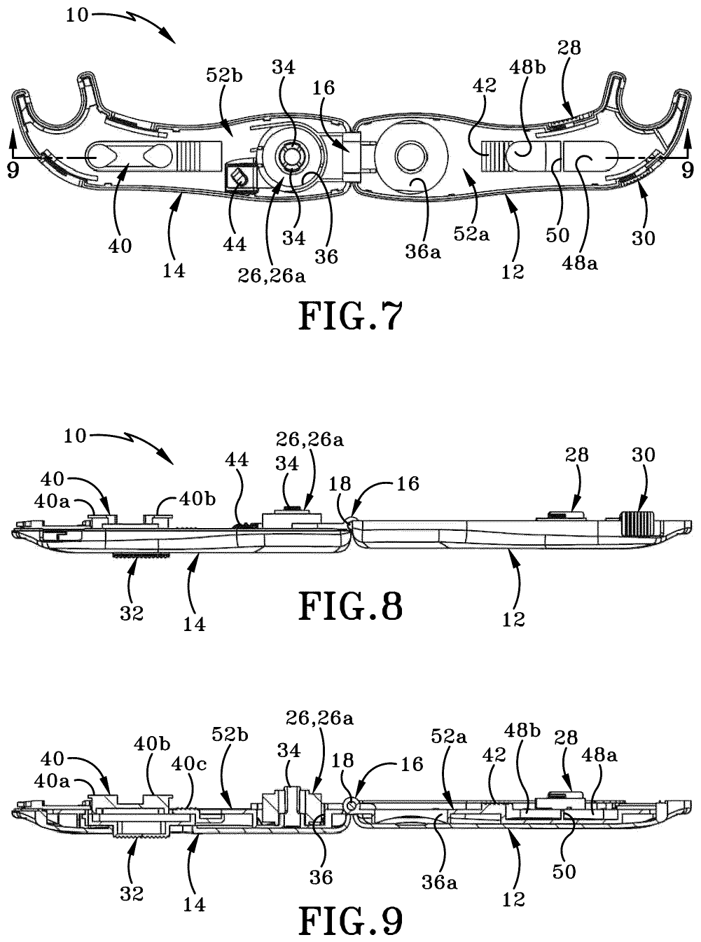

As shown, flossing device 10 is of a clam-shell design, wherein first housing section 12 and second housing section 14 are connected to one another at one end by a hinge 16. Hinge 16 may include a pin 18 (FIG. 5) which enables the first housing section 12 and second housing section 14 to pivot relative to one another. First housing section 12 and second housing section 14 are pivotable about hinge pin 18 so as to be movable between the closed configuration (shown in FIGS. 1-6) and an open configuration (shown in FIGS. 7-11). FIG. 7 shows that flossing device 10 moved to the open configuration for access to inner features, components, or volumes of flossing device 10.

In the embodiment shown, first housing section 12 and a second housing section 14 of flossing device 10 are at least partially separable, so as to open flossing device 10, load dental floss, and extend and tension a length of dental floss. As discussed above, the first housing section 12 and second housing section 14 are rotatably connected by means of hinge 16, which includes pin 18 for pivoting, where one of the first housing section 12 or second housing section 14 rotates relative to the other housing section and into the open configuration. It should be understood, however, that other means of connection one or more housings or of opening or closing at least a portion of flossing device 10, may be used without deviating from the scope or intent of this disclosure. In other embodiments, one housing may rotatably open away from the other housing along the plane of the facing elements of the two housings. In some other embodiments, one housing may be press fit into the other housing, or a snap fit may be used, screws or other fasteners or attachment features may be used, a living hinge may be used, one housing may press against or at least partially into complementary features in the other housing without a hinge, or other means of connection known in the art may be used. It should also be understood that more than two housings or otherwise opening/closing features or elements may also be used.

Flossing device 10 may be of a generally open configuration, may be unitary or monolithic, or may have at least one internal volume formed by first housing section 12 and second housing section 14 when moved to the closed configuration. The at least one internal volume may be accessed by opening at least one feature of flossing device 10. In some embodiments, flossing device 10 may include a dental floss storage or dispensing compartment which may be at least partially open, may be able to be closed or opened for access or replacement of the dental floss, or all or a substantial portion of flossing device 10 may be able to be opened or otherwise accessed for loading or replacement of the dental floss, or for feeding a length of dental floss through at least a portion of flossing device 10, or for tensioning of at least a portion of the length of dental floss.

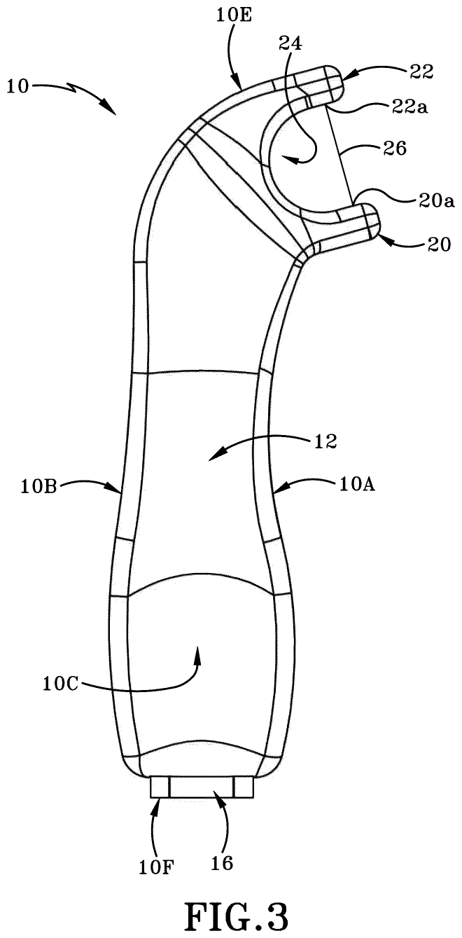

In the embodiment shown, in the prong region of flossing device 10 there are two prominences or prongs. As illustrated, flossing device 10 includes a first prong 20 and a second prong 22 that are spaced apart from one another and define a gap 24 therebetween. A line of dental floss 26 (FIG. 3) or other flossing material 26 may be extended between the first and second prongs 20, 22, while leaving an at least partially open volume or gap 26 between the flossing material 26 and at least one surface of flossing device 10 so as to enable flossing of teeth by the user. The flossing material 26 may extend or rest at least partially along a surface of flossing device 10 or may, as shown, extend from within flossing device 10 proximal to one of the first prong 20 and second prong 22 and return to within flossing device 10 proximal to the other of the first prong 20 and second prong 22. The two prongs 20, 22 are arranged in what is known as an “F-shape” wherein a plane created between the two prongs 20, 22 and including the line of flossing material 26 is substantially within the plane of the handle of flossing device 10, i.e., within the plane of the gripping portion thereof. However, it should be understood that in other embodiments the two prongs could be arranged in a “Y-shape” wherein the plane which includes the two prongs and the flossing material 26 is not in the plane of the handle of flossing device 10. This may occur where the two prongs are perpendicular to that plane or otherwise at a non-parallel angle relative to the plane, without deviating from the scope or intent of this disclosure. It should also be understood that fewer than two prongs or more than two prongs may optionally be provided on an embodiment of the flossing device, such as where the flossing material 26 either exits or returns to the body of flossing device 10 without a prong being present.

When flossing device 10 is in the closed configuration, shown in FIGS. 1-6, flossing device 10 may be considered to have a front 10A, a rear 10B, a left side 10C, a right side 10D, a top 10E, and a bottom 10F. Any of the terms “front”, “rear”, “left”, “right”, “top”, and “bottom” are used herein to describe the orientation of the flossing device 10 illustrated in FIGS. 1-6. It should be understood that this terminology does not limit the orientation in which the flossing device 10 is used when held by the user to floss their teeth or the teeth of another. As is evident from FIG. 3, in particular, first and second prongs 20, 22 extend outwardly and forwardly beyond the front 10A of flossing device 10.

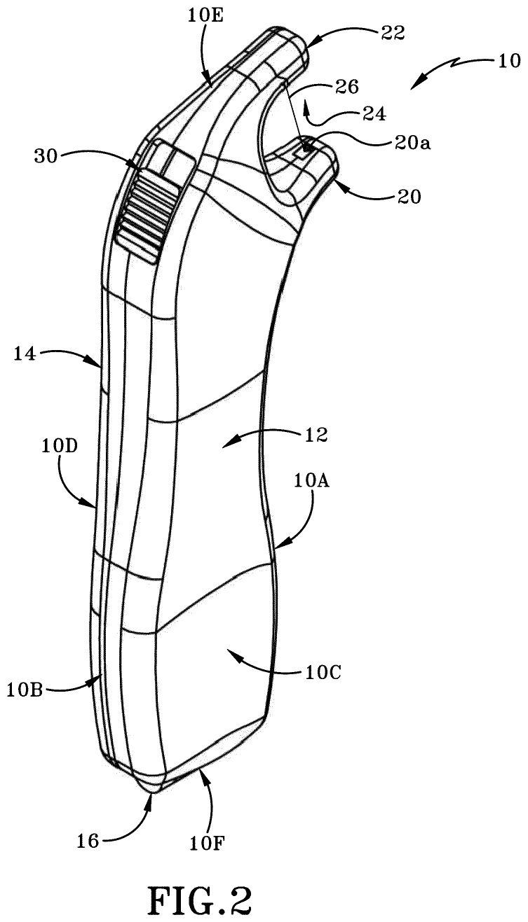

Flossing device 10 may include one or more locking features to aid in retention of flossing device 10 within the housing when in the closed configuration, though no locking features may be necessary in embodiments where a snap fit, light press fit, or other means known in the art are used, including where the user may hold flossing device 10 without a locking feature or where flossing device 10 is not a clam-shell or other closed configuration, but internal components or features are exposed. In the embodiment shown, flossing device 10 includes a front slide lock 28 (FIG. 1) provided on front 10A and a rear slide lock 30 (FIG. 2) provided on rear 10B, though some embodiments may use more or fewer locking mechanisms. As shown, the front slide lock 28 and the rear slide lock 30, upon closing of the second housing section 14 against the first housing section 12, may be slid into a locked configuration. The front slide lock 28 and the rear slide lock 30 may later be manipulated in the opposing direction to unlock flossing device 10. Other means of locking and unlocking first and second housing components 12, 14 of flossing device 10 may also be used, such as rotary locks, push-pull mechanisms, ball-spring plungers, or button locks. One or both of the front slide lock 28 and the rear slide lock 30 may optionally include one or more ridges, teeth, or other features to aid or enable the user being able to slide the locking feature into or out of a locked orientation.

In the embodiment shown, flossing device 10 includes a tensioning slider 32 or tensioning button 32. The tensioning button 32 may be at least partially exposed from the second housing section 14 or the first housing section 12, or may be set within flossing device 10, with an at least partial opening providing access to the tensioning button 32. During use, the user may slide, depress, or otherwise manipulate the tensioning button 32 so as to increase tension on dispensed flossing material 26, such as to tighten the length of flossing material 26 which extends between the first and second prongs 20, 22 of flossing device 10. It should be understood that other means of tensioning the flossing material 26 and other forms of tensioning buttons may also be used, such as a circular tensioner or otherwise rotatable tensioning button.

In the embodiment shown, the user may slide the tensioning button 32 from a location that is more proximal to the user's teeth to a location that is more distal from the user's teeth. The tensioning button 32 may optionally include one or more ridges, teeth, or other features to aid in the user being able to manipulate the tensioning button 32 during tensioning of the flossing material 26.

An embodiment of a flossing device 10 of the present disclosure is shown in the open configuration in FIGS. 7-13. As shown, the housing of flossing device 10 may be at least partially opened to enable insertion or removal of a spool 26a (FIG. 7) of flossing material 26 into the interior of the housing. The spool 26a may be loaded onto a spool retention member 34 which may aid in retaining the spool 26a in a desired orientation, and may also or alternatively aid in proper rotation of the spool 26a during dispensing of flossing material 26. The spool 26a may also optionally at least partially be located within an at least partially open spool cavity 36, which may further aid in spool retention as well as optionally aid in proper desired rotation of the spool 26a during dispensing of flossing material 26. The spool cavity 36 may be in one housing section of flossing device 10 (such as in first housing section 12), with the spool retention member 34 in the same first housing section 12 of flossing device 10, or the spool retention member 34 may be seated in a complementary spool cavity 36a (FIG. 7) in second housing section 14 of flossing device 10 relative to the one containing the spool cavity 36. In some embodiments, there may be no spool retention member 34 or no spool cavity 36, 36a, or there may be more than one of either or both. In the embodiment shown, there is a spool cavity 36 in the first housing section 12, with the spool retention member 34 extending from that spool cavity 36. The second housing section 14 has a second spool cavity 36a, creating space for the portion of the spool 26a of flossing material 26 that does not fit within the profile of the first housing section 12 while also creating space for the portion of the spool retention member 34 which extends beyond the height of the spool 26a, though, as shown, it optionally does not include a second spool retention member 34. It should be understood that other configurations or packaging of flossing material 26 may also be used, such as dental floss pods, rectangular or otherwise polygonal dental floss containers or packaging, or lengths of dental floss folded or rolled to fit within flossing device 10, without deviating from the scope or intent of this disclosure.

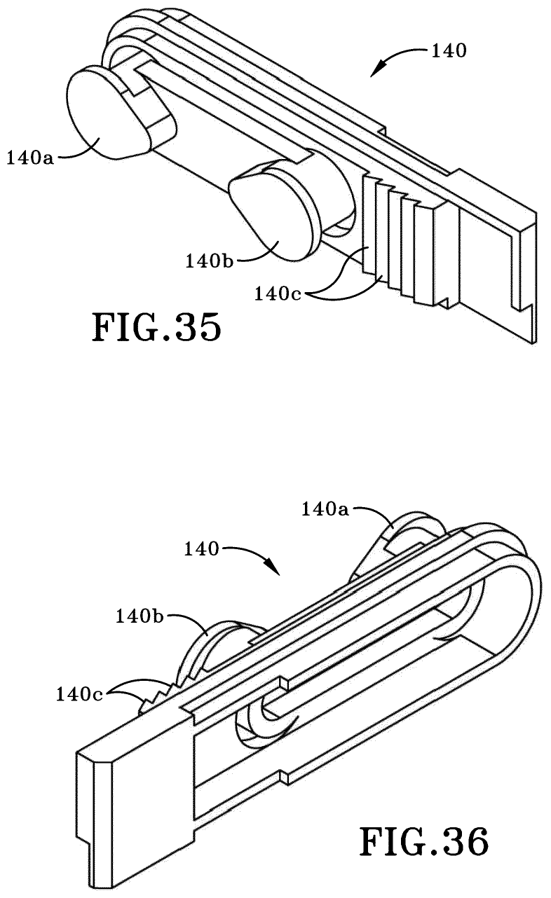

In preparation for use, a spool 26a or other form factor of flossing material 26 may be at least partially inserted into or onto flossing device 10, such as onto retention member 34 or into spool cavity 36. A length of flossing material 26 may be extended from the spool 26a, providing sufficient floss length for loading onto a floss anchor as well as between first and second prongs 20, 22 of flossing device 10. In one method of use, a length of floss that is approximately three times the length of flossing device 10 is extended from the spool 26a. The dental floss may then be engaged with a floss anchor 40. For example, the length of floss 26 wrapped around one or more cleats 40a, 40b or other features, such as prominences, of floss anchor 40. The floss anchor 40, or the one or more cleats 40a, 40b or prominences of the floss anchor 40, may be unitary with the tensioning button 32, such as where they are formed of a single monolithic piece of material (as in FIGS. 35 to 41), or may be separate, such as where the floss anchor 40 and the one or more cleats 40a, 40b form a subassembly (as in FIGS. 7-13). The floss anchor 40, its optional subcomponents, as well as any or all of the components of flossing device 10, may be made of plastic, such as by means of injection molding, machining, or additive manufacturing, may be made of metal, such as by machining, may be composite materials, such as resin or resin infused with fibers or other materials, or may be a combination of materials, such as those known in the art.

In one embodiment, flossing device 10 and its components are made of food-safe and washable materials which maintain substantially stable structural properties, dimensions, and tolerances when subjected to ambient or room temperatures. In other embodiments, flossing device 10 and components are made of materials suitable for hand washing, machine washing, and typical temperatures of recommended household water boilers. Some or all of the components of flossing device 10 may be made of high density poly ethylene (HDPE) or may be made of polytetrafluorethylene (PTFE). In some preferred embodiments, as many of the components of flossing device 10 are made of recyclable or eco-friendly materials as is reasonably feasible.

In one method of use, the length of extended flossing material 26 may be wrapped around one or more cleats 40a, 40b of the floss anchor 40. The floss anchor 40 may be slidably connected to flossing device 10 or may rest at least partially against or within the housing of flossing device 10. In a preferred method of use, the floss anchor 40 is extended and located in an orientation proximal to the second prong 22 when the flossing material 26 is wrapped around a feature of the floss anchor 40. In such a way, maximum potential tensioning of the flossing material 26 may be enabled. The floss anchor 40 may include one or more ridges of teeth 40c, such as extending inwards of the closed flossing device 10 or away from the outer side of the housing section which at least partially contains the floss anchor 40 when flossing device 10 is in the open configuration, i.e., second housing section 14. The other housing section, i.e., first housing section 12, may optionally further include one or more complementary retention teeth 42 (FIG. 7), ridges, or other features which may be configured to interfere, interact, or interconnect with the teeth 40c, ridges, or other features of the floss anchor 40. The retention teeth 42 may be configured to resist movement of the floss anchor teeth 40c, or to restrict movement of the floss anchor 40 unidirectionally, such as through a ratcheting mechanism, when flossing device 10 is in the closed configuration. In the embodiment shown, the floss anchor 40 rests partially within first housing section 12 and includes a plurality of teeth 40c, in a saw-tooth configuration. The second housing section 14 includes a plurality of retention teeth 42 which, in combination with the saw-tooth configuration of the floss anchor teeth 40c, only allow motion of the floss anchor 40 in one direction when flossing device 10 is in the closed configuration, thus enabling tensioning of exposed flossing material 26 while not allowing the floss anchor 40 to move back towards an un-tensioned orientation. It should be understood that either or both of the floss anchor teeth 40c and the retention teeth 42 could have a saw-tooth configuration, or other means of ratcheting of the floss anchor 40 could also be used, without deviating from the scope or intent of this disclosure. In one alternate embodiment, which is not shown, the floss anchor may rest partially within a slot in a housing section which has a toothed configuration or other features which are complementary to teeth or other features on the floss anchor, such as on its sides or bottom.

Returning to one method of use of loading flossing device 10, the flossing material 26 may be wrapped at least partially around a first cleat 40a, then at least partially around the second cleat 40b, then return to the first cleat 40a, such as in making a figure-eight motion or pattern. In one method of use, the flossing material 26 is wrapped around the first and second cleat 40a, 40b two to three times, though other numbers of wrappings may be used, or only one cleat (either 40a or 40b) may be used, without deviating from the scope or intent of this disclosure.

The length of flossing material 26 may then be extended towards first prong 20, out of the profile of flossing device 10 through a first aperture 20a (FIG. 5), towards second prong 22, and then back into the profile of flossing device 10 through a second aperture 20b. It should be understood that fewer than two prongs 20, 22 may be present, such as where the length of floss exits flossing device 10 or enters flossing device 10 through an at least partial opening without a prong being present.

The flossing material 26 may then be optionally directed back towards the floss anchor 40, where it may then optionally be wrapped around the one or more cleats 40a, and 40b again. In one method of use, the flossing material 26 is wrapped around the cleats 40a, 40b one to three additional times, again in a figure-eight configuration, though more or fewer wrappings may also be used, as well as more of fewer cleats 40a, 40b.

After wrapping the final time around the one or more features of the floss anchor 40, a floss cutter 44 (FIG. 7) or cutting blade may be used to cut away any excess length of flossing material 26. The floss cutter 44 may be metal, though other materials known in the art may also be used. In the embodiment shown, the floss cutter 44 is a component of flossing device 10, though it should be understood that the floss cutter may also be a separate component, or may be entirely absent. The floss cutter 44 is shown as being fully within the footprint of flossing device 10 and is fully closed off, with no external access, when flossing device 10 is in the closed configuration, though it should be understood that some or all of the floss cutter 44 may be external to the body of flossing device 10 without deviating from the scope or intent of this disclosure.

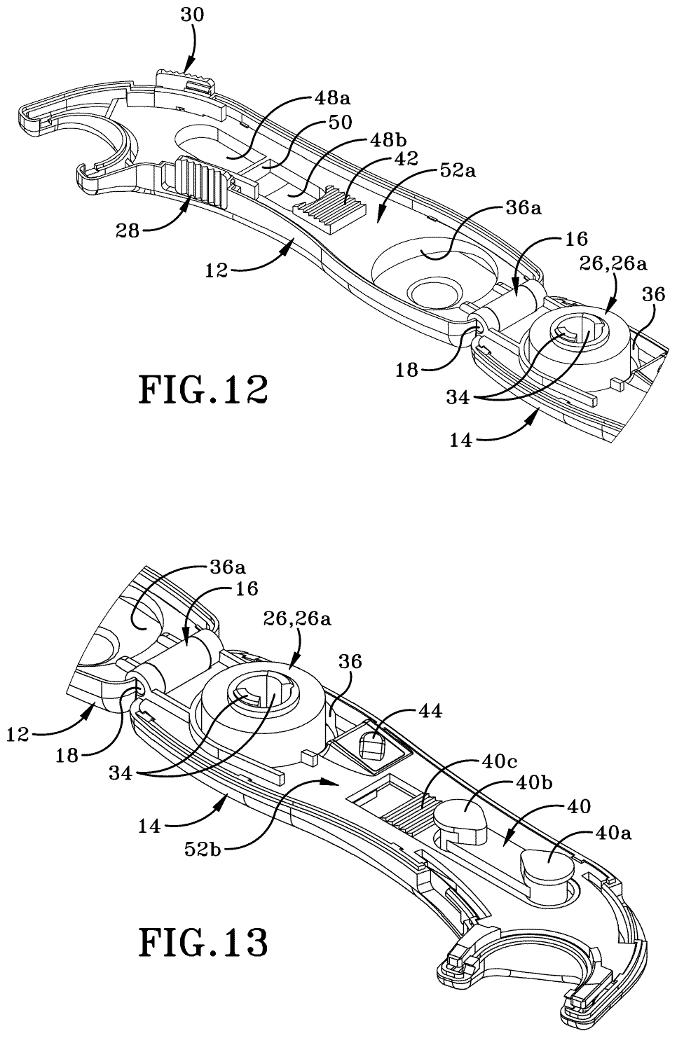

Once the flossing material 26 has been wrapped at least partially around the floss anchor 40 and a desired length of flossing material 26 has been optionally cut, flossing device 10 may be closed into the closed configuration. One of the first and second housing components 12, 14 of flossing device 10 may optionally include a feature configured to aid in tensioning the flossing material 26 against the floss anchor 40 or between the cleats 40a, 40b of the floss anchor 40, such as a cross bar 50. In the embodiment shown, the first housing section 12 which does not hold the spool 26a when flossing device 10 is in the open configuration may include a one or more cleat cavities which are separated from one another by a cross bar. As best seen in FIG. 12, the first housing section 12 includes two cleat cavities 48a, 48b (FIG. 7) which are separated from one another by cross bar 50. Each cleat cavity 48a, 48b is configured to at least partially receive therein one of the one or more cleats 40a, 40b from the floss anchor 40, or other features of the floss anchor 40 when flossing device 10 is moved to the closed configuration. As shown, each cleat 40a, 40b may rest in a respective cleat cavity 48a, 48b, separated by the cross bar 50. The cross bar 50 may press against at least a portion of the flossing material 26 which has been wrapped between the cleats 40a, 40b, thus aiding in retention of the flossing material 26 and in preventing slippage of the flossing material 26 when flossing device 10 is in the closed configuration.

When flossing device 10 is in the closed configuration, one or more locking features, such as the front slide lock 28 and the rear slide lock 30, may be engaged to aid in retention of flossing device 10 in the closed configuration. The tensioning button 32 may then be optionally actuated, such as by sliding tensioning button 32 distally away from the one or more prongs 20, 22 of flossing device 10, so that the user may achieve a desired tension of the flossing material 26 extending between the first prong 20 and the second prong 22.

If the user wishes to extend an additional length of floss 26, the locking features, i.e., front slide lock 28 and/or rear slide lock 30, may be unlocked and flossing device 10 may be returned to an at least partially open configuration. The flossing material 26 may then be unwrapped from the floss anchor 40, an additional length of flossing material 26 may be extended from the spool 26a, such as by pulling, and then the process of loading, closing, and tensioning of the flossing material 26 may be repeated.

In the embodiment shown, the floss anchor 40 includes two cleats 40a, 40b, wherein flossing material 26 is at least partially wrapped around a portion of the floss anchor 40, then extended between the two prongs 20, 22, and then again wrapped at least partially around a portion of the floss anchor 40. However, in other embodiments and in other methods of use, the floss anchor 40 may only be used during one wrapping step of the loading and tensioning process. In one such embodiment, which is not shown, flossing material 26 may extend and be at least partially wrapped around a wrapping post or other stationary feature, such as a feature that is proximal or within the spool cavity 36. Flossing material 26 may then be extended between the one or more prongs 20, 22, and then be wrapped around the floss anchor 40.

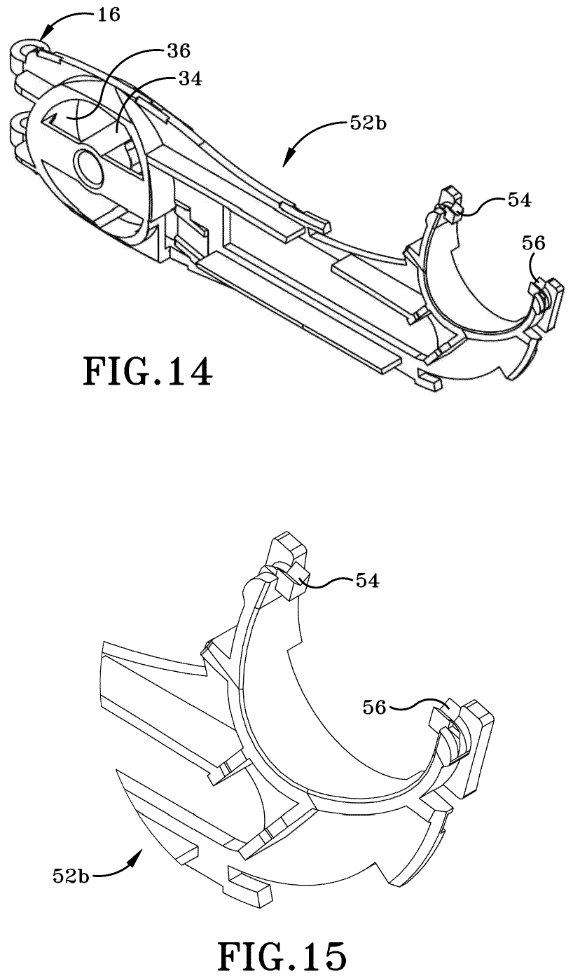

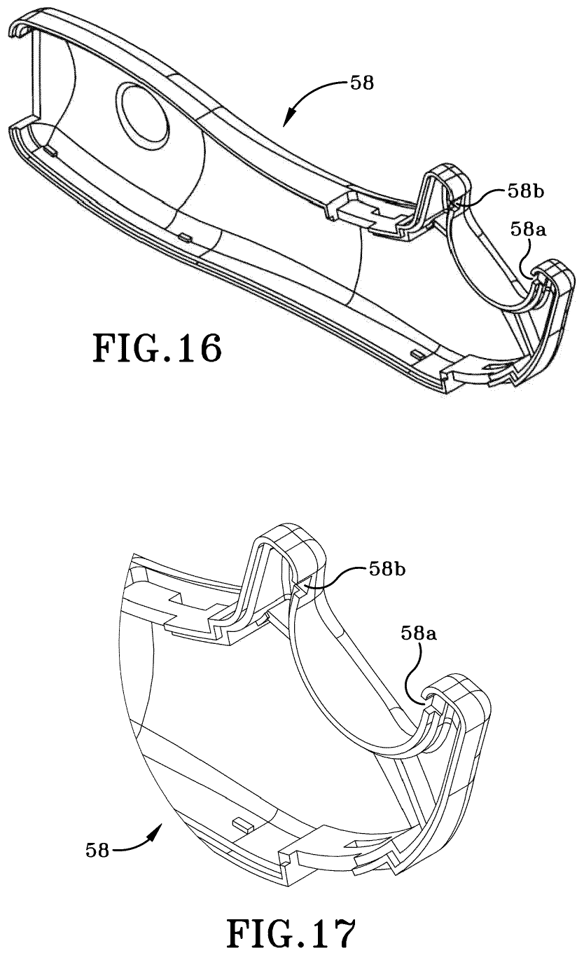

As best seen in FIG. 1A, each of the first housing section 12 and second housing section 14 of the illustrated embodiment of flosser device 10 comprises a housing component and a chassis component. The housing components, together, form an outer shell of the flosser device 10. The chassis components, numbered “52a” and “52h” are configured to be inserted into an interior compartment defined by the walls of the associated one of the housing components. In particular, a first chassis component 52a may be seated at least partially within or against a first housing component to form first housing section 12. A second chassis component 52b may be seated at least partially within or against a second housing component to form second housing section 14. In some embodiments, both the first housing component and the second housing component may include an associated chassis component 52a, 52b. In other embodiments, only one of the first housing component and second housing component may receive an associated chassis component. In some embodiments, the features of the chassis component 52a or 52b may be incorporated into a respective housing component, obviating the need for some or all of that respective chassis component 52a, 52b. FIGS. 14 and 15 show second chassis component 52n includes two guide features 54, 56, though in other embodiments there may be no guide features, or only one guide feature, or more than two guide features. As shown, the guide features 54, 56 aid in directing and retaining the flossing material 26 in a desired location, such as against chassis 52b (FIG. 15) or extending directly from or to first and second prongs 20, 22 of flossing device 10. Each of the first and second housing components, such as the housing component 58 shown in FIGS. 16-17, may include one or more at least partial openings 58a, 58b configured to aid in guiding flossing material 26 or, as shown, receive at least a portion of the one or more guide features 54, 56. When the first housing component and second housing component are engaged with one another, the partial openings 58a, 58b on the two housing components 58 will, together, form openings 22a, 22b (FIGS. 1-6) through which flossing material 26 is guided.

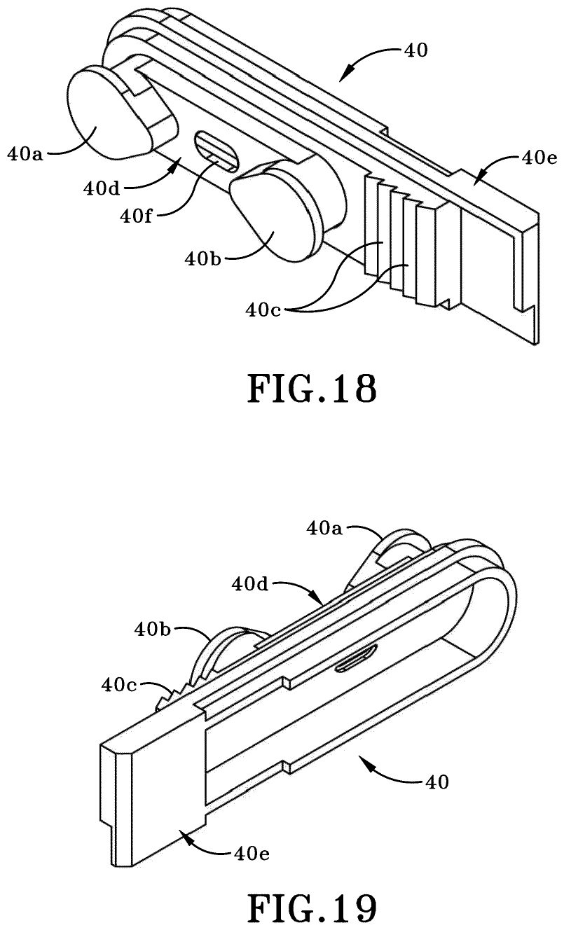

An embodiment of a floss anchor 40 is shown in FIGS. 18-24. In this embodiment, the floss anchor 40 is a subassembly and includes a cleat fixture 40d (FIG. 21) and a slider component 40e. The cleat fixture 40d may be connected to the slider component 40e by means of a snap fit, as shown, a press fit, welding, heat-initiated deformation, adhesives, fasteners, or other means known in the art. Though the floss anchor teeth 40c are shown in this embodiment as part of the slider component 40e, it should be understood that the floss anchor teeth 40c could alternatively be part of the cleat fixture 40d, or could be one or more separate components. It should also be understood that the floss anchor 40 could be made from the slider component 40e and one or more pin or pin-like components, which may be inserted or affixed into or onto the slider component 40e, as opposed to a single cleat fixture 40d which includes multiple cleats (such as cleats 40a, 40b), without deviating from the scope or intent of this disclosure.

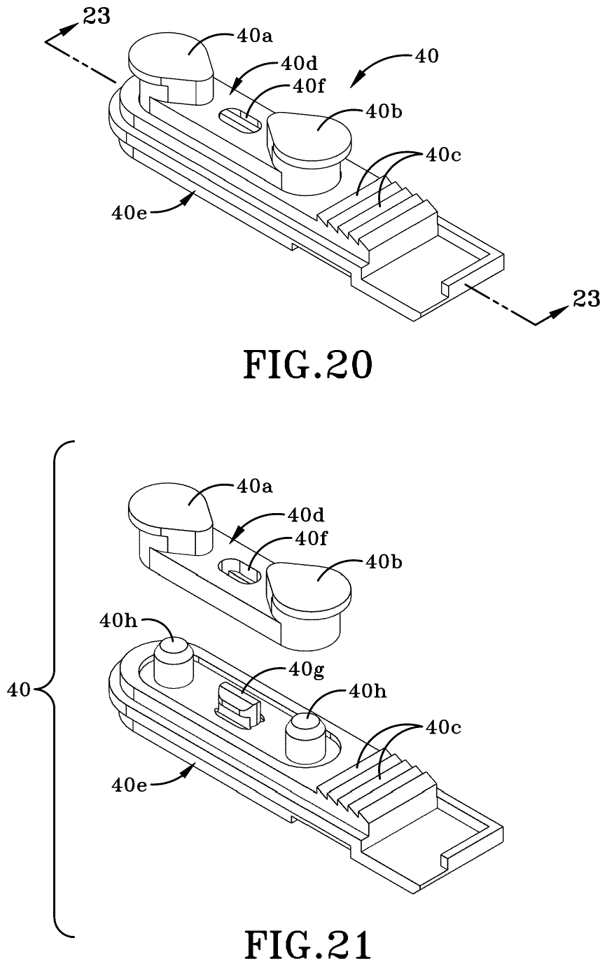

In embodiments where the cleat fixture 40d and the slider component 40e may be separate components, or where at least one cleat 40a, 40b may be a separate component from the slider component 40e, the cleat fixture 40d may be connected to the slider component 40e through various optional means, as discussed above. In the embodiments of the cleat fixture 40d and the slider component 40e shown in FIGS. 20-34, the cleat fixture 40d may connect to the slider component 40e by means of a snap fit feature. In the embodiment shown, the cleat fixture 40d includes a snap fit recess 40f (FIG. 21), which may be configured to at least partially receive at least one complementary pronged or other snap fit protrusion 40g which may extend from at least one surface of the slider component 40e. It should be understood that, though the snap fit recess 40f is shown as a feature of the cleat fixture 40d and the snap fit protrusion 40g is shown as a feature of the slider component 40e, the relative locations and relative components of the snap fit recess 40f and the snap fit protrusion 40g may be interchanged, or combinations of such features may be on the two components or on other components of the device, without deviating from the scope or intent of this disclosure. One or both of the cleat fixture 40d or the slider component 40e may include at least one receiving recess 40f configured to receive at least a portion of, or a feature of, the other component 40g, or both components may optionally include a receiving recess, so as to aid in location and retention of the cleat fixture relative 40d to the slider component 40e.

To further aid in location or retention of the cleat fixture 40d relative to the slider component 40e, one or both components may optionally include one or more dowel features 40h, which may additionally aid in or be present to function in resisting rotation of the cleat fixture relative to the slider component. Though the embodiment shown in FIGS. 21 and 23 depicts the slider component 40e including two dowel features 40h, and the cleat fixture 40d including two complementary dowel recesses 40j, it should be understood that other numbers of dowel features, dowel recesses, other functionally similar features, and other relative locations of the dowel features and dowel recesses, may also be used without deviating from the scope or intent of this disclosure.

It should be understood that, in embodiments where one or more cleats 40a, 40b or cleat fixtures are separate components, such as where the cleat fixture 40d is a separate component from the slider component 40e, the cleat fixture 40d and other components, such as the sliders component 40e, or individual cleats 40a, 40b, may be made of different materials, including where different amounts of flexibility, rigidity, or surface friction may be desirable. This material differentiation may apply to any or all components, features, or elements of the device as well. In one embodiment, one or more cleats 40a, 40b, or the entire cleat fixture 40d, may be made of thermoplastic polyurethane (TPU) or another rubber-like material. It should further be understood that the cleat fixture 40d may be made partially or substantially of one material, while one or more cleats 40a, 40b may be separate or attached components of a different material. In some embodiments, the slider component 40e, or the entire floss anchor 40, may be made of high density poly ethylene (HDPE) or a similar plastic material. In some embodiments, at least some components of the device may be made of recyclable or otherwise eco-friendly material or materials.

Additionally and alternatively to the embodiments shown in FIGS. 18-24, in other embodiments, such as the second embodiment of the floss anchor assembly shown in FIGS. 35-36, the floss anchor 140 may be a unitary component, or one or more cleats 140a, 140b may additionally or optionally be unitary with the slider component 140e. As shown in FIGS. 35-36, a unitary floss anchor 40 may optionally include the cleats 140a, 140b as well as, in some embodiments, the floss anchor teeth 140c.

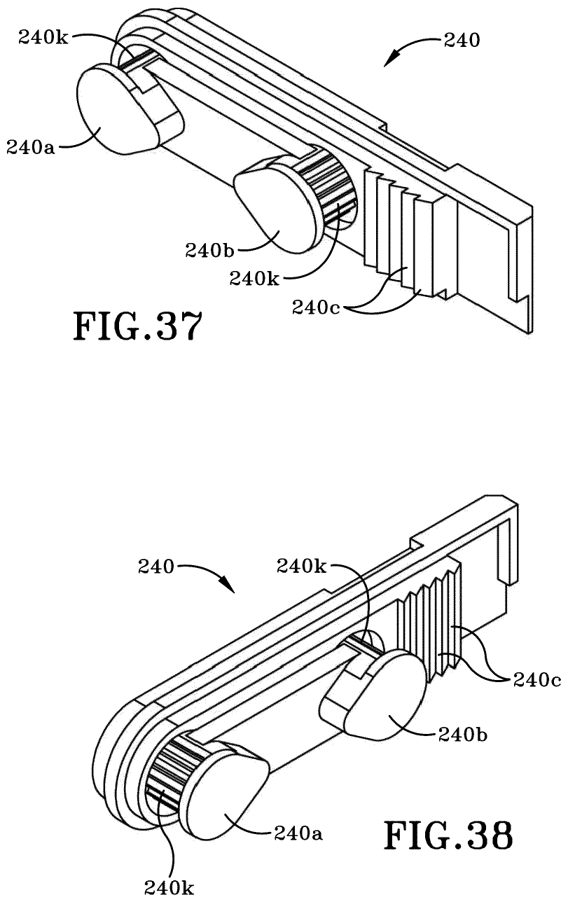

Though one or more sides of the cleats 40a, 40b or 140a, 140b may be smooth or substantially smooth, as shown in FIGS. 18-36, alternate embodiments of the floss anchor 40 or 140 may include one or more ridges, teeth, or other surface features on one or more sides of the cleats 40a, 40b or 140a, 140b. For example, as shown in the third embodiment of the floss anchor assembly presented in FIGS. 37-41 and generally indicated at 240, one or more sides of one or more cleats 240a, 240b may optionally include retention features such as anchor retention teeth 240k. The anchor retention teeth 240k may aid in retaining the wrapped or partially wrapped length of flossing material 26 against the cleats 240a, 240b and in relation to the floss anchor 240.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention. Accordingly, various modifications, adaptations, combinations, and alternatives may occur to one skilled in the art without departing from the spirit of the invention and scope of the claimed coverage.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature, or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description, and illustration of various embodiments of the disclosure are examples and the disclosure is not limited to the exact details shown or described.

What is claimed is:

1. A flossing device, comprising:
a first housing section, configured to at least partially receive a unit of flossing material;
a second housing section; and
a tensioning component;
wherein at least one of the first housing section and the second housing section is further configured to at least partially receive the tensioning component therein and the other of the first housing section and the second housing section is configured to aid in retention of the tensioning component when the flossing device is in a closed configuration.

2. The flossing device according to claim 1, wherein the tensioning component is configured to resist motion of a portion of flossing material of the unit of flossing material when the flossing device is in the closed configuration.

3. The flossing device according to claim 1, wherein the unit of flossing material is a spool of dental floss and wherein the flossing device further comprises a spool cavity defined by the first housing section, wherein the spool cavity is configured to receive at least a portion of the spool of dental floss therein.

4. The flossing device according to claim 1, further comprising at least one floss cleat provided on the tensioning component.

5. The flossing device according to claim 4, further comprising at least one floss retention tooth on the at least one floss cleat.

6. The flossing device according to claim 4, further comprising at least one ratcheting tooth provided on the tensioning component.

7. The flossing device according to claim 1, wherein the tensioning component is slidably connected to the first housing section.

8. The flossing device according to claim 1, wherein the tensioning component is at least partially exposed from a surface of the flossing device when the flossing device is in the closed configuration.

9. The flossing device according to claim 1, wherein the second housing section comprises at least one motion retention tooth, configured to resist motion of the tensioning component in at least one direction when the flossing device is in the closed configuration.

10. The flossing device according to claim 1, further comprising at least one prong provided on at least one of the first housing section and the second housing section, wherein the at least one prong at least partially defines an at least partially open dental volume between the at least one prong and at least one surface of the at least one of the first housing section and the second housing section to enable flossing of teeth by a user.

11. The flossing device according to claim 1, further comprising a chassis component, wherein at least one of the first housing section and the second housing section is configured to receive the chassis component.

12. The flossing device according to claim 11, further comprising at least one guide feature provided on the chassis component, and wherein the at least one guide feature is configured to direct a length of flossing material out of the flossing device or into the flossing device.

13. The flossing device according to claim 1, further comprising a mechanical hinge connecting the first housing section and the second housing section to one another.

14. The flossing device according to claim 1, further comprising at least one locking feature which is configured to aid in retention of the flossing device in the closed configured when the at least one locking feature is in a locked orientation.

15. A flossing device, comprising:
a first housing section;
a second housing section;
a tensioning component;
a mechanical hinge connecting the first housing section and second housing section to one another, wherein the first housing section and second housing section are movable relative to one another between a closed configuration and an open configuration;
at least one locking mechanism configured to aid in retention of the flossing device in the closed configuration;
wherein the tensioning component is slidably connected to the first housing section and the tensioning component comprises two floss retention cleats, wherein the two floss retention cleats are configured to resist motion of a length of dental floss when the length of dental floss is wrapped at least partially around and between the two floss retention cleats; and
wherein the tensioning component further comprises at least one tensioning tooth; at least one motion-resistance tooth provided on one of the first housing section and the second housing section, wherein the at least one motion-resistance tooth is configured to resist motion of the tensioning component when the flossing device is in the closed configuration.

16. The flossing device according to claim 15, wherein the flossing device is configured to receive a spool of dental floss therein, and wherein the spool of dental floss is fully enclosed by the first housing section and the second housing section when the flossing device is in the closed configuration.

17. The flossing device according to claim 15, further comprising a floss cutting feature provided on the flossing device, wherein the floss cutting feature is fully enclosed by the first housing section and the second housing section when the flossing device is in the closed configuration.

18. A method of using a flossing device, comprising:
inserting a spool of flossing material into a first housing section of a flossing device;
extending a length of dental floss from the spool of flossing material;
at least partially wrapping at least a first portion of the length of dental floss around a first cleat of the flossing device;
extending at least a second portion of the length of dental floss out of the flossing device through a first prong of the flossing device;
returning at least a third portion of the length of dental floss into the flossing device through a second prong;
at least partially wrapping a fourth portion of the length of dental floss around a second cleat of a tensioning component; and
resisting motion of the tensioning component in at least one direction with a second housing section of the flossing device and when the flossing device is in a closed configuration.

19. The method of using a flossing device according to claim 18, further comprising slidably connecting a tensioning feature on the tensioning component to the first housing section of the flossing device, and wherein the tensioning component comprises the first cleat of the flossing device.

20. The method of using a flossing device according to claim 18, further comprising cutting a fifth portion of the length of dental floss off from the fourth portion of the length of dental floss using a floss cutter which is connected to the flossing device and is fully enclosed by the first housing section and the second housing section when the flossing device is in the closed configuration.
